(19) United States
(12) Patent Application Publication
(10) Pub. No.: US 2015/0268650 A1
(43) Pub. Date: Sep. 24, 2015

(54) POWER MODELING BASED BUILDING DEMAND MANAGEMENT SYSTEM

(71) Applicant: NEC Laboratories America, Inc., Princeton, NJ (US)

(72) Inventors: Rakesh Patil, San Francisco, CA (US); Ratnesh Sharma, Fremont, CA (US); Cara Touretzky, Bridgewater, NJ (US)

(21) Appl. No.: 14/531,582

(22) Filed: Nov. 3, 2014

Related U.S. Application Data
(60) Provisional application No. 61/969,523, filed on Mar. 24, 2014.
(60) Provisional application No. 62/039,944, filed on Aug. 21, 2014.

(51) Int. Cl. G05B 17/02; G05F 1/66

(52) U.S. Cl. CPC G05B 17/02; G05F 1/66

(57) ABSTRACT

A method and system are provided. The method includes generating a power model, modeling power demands of at least one of a building and subsystems thereof, responsive to measured power-related inputs specific to the building and forecasted power-related inputs. The method further includes controlling, by a processor-based supervisory controller, power consumption of at least one of the building and the subsystems responsive to the power demands modeled by the power model.

### RELATED APPLICATION INFORMATION

This application claims priority to provisional application Ser. No. 61/969,523 filed on Mar. 24, 2014 and to provisional application Se. No. 62/039,944 filed on Aug. 21, 2014, incorporated herein by reference.

### BACKGROUND

1. Technical Field

The present invention relates to data processing, and more particularly to a power modeling based building demand management system.

2. Description of the Related Art

Commercial Buildings have different types of power demands whose advanced monitoring and control can reduce energy consumption. A challenge in controlling the demands of individual buildings is to obtain models that can evaluate and forecast their power consumption. Though several models exist to predict future power demands, these models have been applied only to forecast grid level loads or an aggregation of loads and not for individual buildings and building subsystems. On the other hand, several building modeling approaches capture the thermodynamics in the building but do not provide any flexibility in calculating power consumption.

Previous approaches, both theoretical and implementation-oriented, have focused on specific aspects of the problem. At the building level, the majority of modeling work for energy management purposes involves developing models of thermodynamics and airflow. In one such approach, to implement model predictive control (MPC—the most frequently proposed advanced controller for buildings), identifying a good model of the building is a crucial step that takes up the majority of installation time. However, these models are for the building thermodynamics and do not directly represent what building owners and the utility are ultimately concerned with, namely power consumption. In addition, the focus is too building specific and comfort related variables are the primary concern.

Short term load forecasting for nonresidential buildings is frequently performed at the grid level but rarely for individual buildings in spite of the potential usefulness of such information. As there are no handles or variables (such as temperature set-points or occupancy) to control or modify the power demands in such prior modeling work, it is not amenable to be incorporated in a control framework for Building Energy Management Systems (BEMS).

Thus, there is a need for a widely scalable and easily implementable all-encompassing approach to modeling an individual building and its subsystem's power demands.

### SUMMARY

These and other drawbacks and disadvantages of the prior art are addressed by the present principles, which are directed to power modeling based building demand management system.

According to an aspect of the present principles, a method is provided. The method includes generating a power model, modeling power demands of at least one of a building and subsystems thereof, responsive to measured power-related inputs specific to the building and forecasted power-related inputs. The method further includes controlling, by a processor-based supervisory controller, power consumption of at least one of the building and the subsystems responsive to the power demands modeled by the power model.

According to another aspect of the present principles, a system is provided. The system includes a power modeler for generating a power model, modeling power demands of at least one of a building and subsystems thereof, responsive to measured power-related inputs specific to the building and forecasted power-related inputs. The system further includes a processor-based supervisory controller for controlling power consumption of at least one of the building and the subsystems responsive to the power demands modeled by the power model.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 shows an exemplary processing system 100 to which the present principles may be applied, according to an embodiment of the present principles;

FIG. 2 shows an exemplary architecture for a system 200 for power modeling based building demand management, in accordance with an embodiment of the present principles;

FIG. 3 shows an exemplary method 300 for power modeling based building demand management, in accordance with an embodiment of the present principles; and

FIG. 4 shows an exemplary architecture 400 for a power modeling based building demand management, in accordance with an embodiment of the present principles.

### DETAILED DESCRIPTION OF PREFERRED EMBODIMENTS

The present principles are directed to power modeling based building demand management system. The present principles can be used with respect to any type of building including, but not limited to, residential, industrial and commercial buildings.

Advantageously, the present principles bridge the gap between the commercial building's demand control and its interaction with the utility. In order to develop such a framework, a model that easily captures and forecasts a building's different power demands is necessary. This model can then be used for a variety of purposes from obtaining schedules to controlling specific loads to participating in Demand Response (DR) programs with minimum cost and comfort impact for the owner of the commercial building. In addition, the large variation in commercial building architectures and uses pose a difficulty when formulating a control structure that could be easily deployed in any setting. The model development process as well as its usage is general enough to be applied to the control of a variety of demand devices and types of buildings.

Advantageously, the present principles provide a power modeling approach that relates local control variables to the power consumption for different demands in the building and the total building power consumption. This model offers the following advantages in BEMS. First, it provides a model that relates local variables such as temperature set-points, occupancy patterns, and so forth to the power consumption of an individual building. In this manner, the model can help in performance evaluation and in forecasting future costs. The forecasts at the local level can also be utilized by the utility in improving their load forecasts and distribution system loading. Second, the model can be inverted to solve for variables such as the temperature set-points in order to achieve a certain power demand profile. This means that the model can be utilized to assess the feasibility of various DR programs at the individual building level. Finally, and more importantly, by relating the set-points to power consumption, this approach provides the flexibility to incorporate power related metrics in control decision making as well as in optimizing the performance of the controller.

It should also be noted that the present principles are easily scalable to be applied to a variety of buildings and different types of loads in buildings whose measurements can be obtained. The approach is also computationally cheap and can be repeated easily to decide the number of variables, and the size and fit of the model to a specific building. In this manner, our approach can be easily adapted to a variety of buildings and demand devices in the buildings.

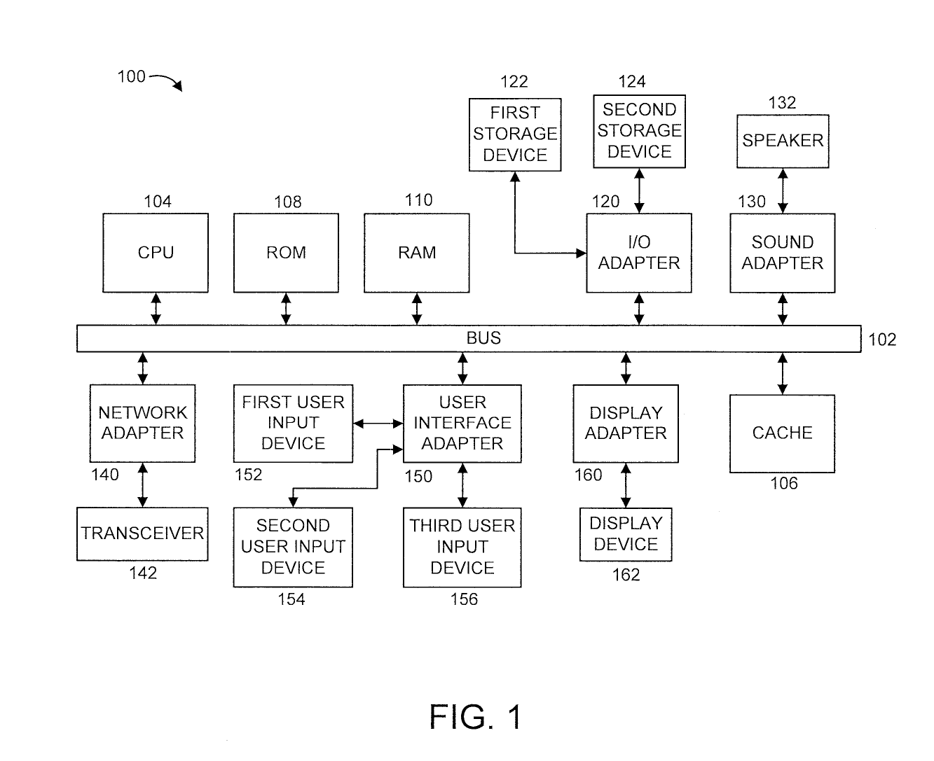

FIG. 1 shows an exemplary processing system 100 to which the present principles may be applied, according to an embodiment of the present principles. The processing system 100 includes at least one processor (CPU) 104 operatively coupled to other components via a system bus 102. A cache 106, a Read Only Memory (ROM) 108, a Random Access Memory (RAM) 110, an input/output (I/O) adapter 120, a sound adapter 130, a network adapter 140, a user interface adapter 150, and a display adapter 160, are operatively coupled to the system bus 102.

A first storage device 122 and a second storage device 124 are operatively coupled to system bus 102 by the I/O adapter 120. The storage devices 122 and 124 can be any of a disk storage device (e.g., a magnetic or optical disk storage device), a solid state magnetic device, and so forth. The storage devices 122 and 124 can be the same type of storage device or different types of storage devices.

A speaker 132 is operatively coupled to system bus 102 by the sound adapter 130. A transceiver 142 is operatively coupled to system bus 102 by network adapter 140. A display device 162 is operatively coupled to system bus 102 by display adapter 160.

A first user input device 152, a second user input device 154, and a third user input device 156 are operatively coupled to system bus 102 by user interface adapter 150. The user input devices 152, 154, and 156 can be any of a keyboard, a mouse, a keypad, an image capture device, a motion sensing device, a microphone, a device incorporating the functionality of at least two of the preceding devices, and so forth. Of course, other types of input devices can also be used, while maintaining the spirit of the present principles. The user input devices 152, 154, and 156 can be the same type of user input device or different types of user input devices. The user input devices 152, 154, and 156 are used to input and output information to and from system 100.

Of course, the processing system 100 may also include other elements (not shown), as readily contemplated by one of skill in the art, as well as omit certain elements. For example, various other input devices and/or output devices can be included in processing system 100, depending upon the particular implementation of the same, as readily understood by one of ordinary skill in the art. For example, various types of wireless and/or wired input and/or output devices can be used. Moreover, additional processors, controllers, memories, and so forth, in various configurations can also be utilized as readily appreciated by one of ordinary skill in the art. These and other variations of the processing system 100 are readily contemplated by one of ordinary skill in the art given the teachings of the present principles provided herein.

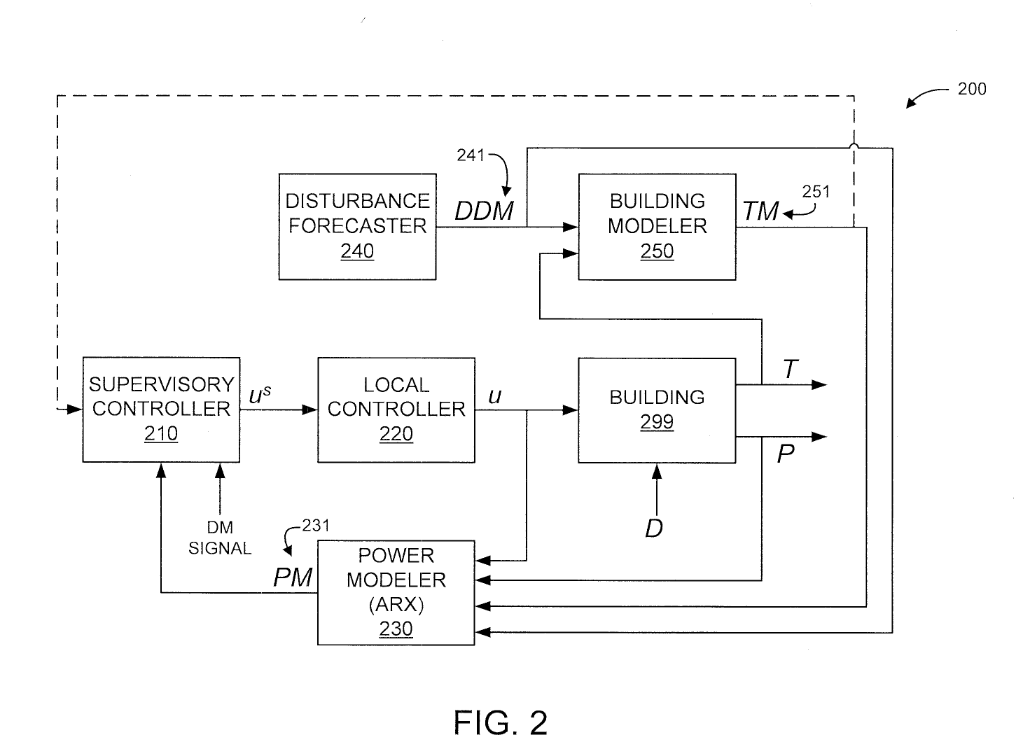

Moreover, it is to be appreciated that system 200 described below with respect to FIG. 2 is a system for implementing respective embodiments of the present principles. Part or all of processing system 100 may be implemented in one or more of the elements of system 200.

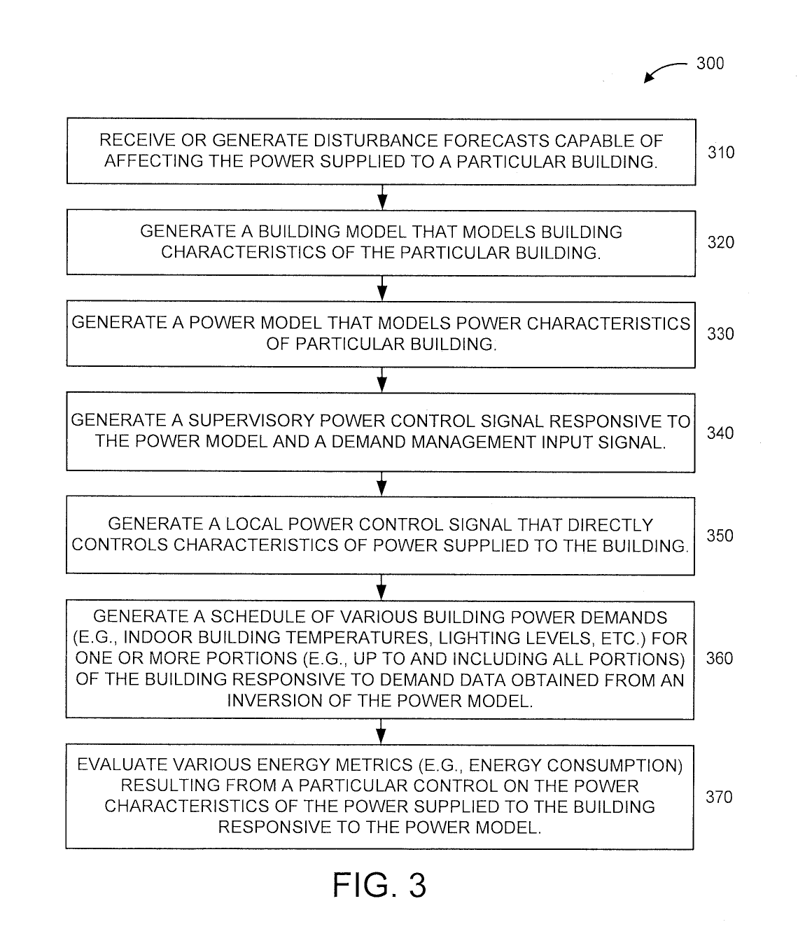

Further, it is to be appreciated that processing system 100 may perform at least part of the methods described herein including, for example, at least part of method 300 of FIG. 3. Similarly, part or all of system 200 may be used to perform at least part of method 300 of FIG. 3.

FIG. 2 shows an exemplary architecture for a system 200 for power modeling based building demand management, in accordance with an embodiment of the present principles. The system 200 includes a supervisory controller 210, a local controller 220, a power modeler 230, a disturbance forecaster 240, and a building modeler 250. The system 200 interacts with a building 299.

The system 200 can be used, for example, for building or room energy management. In FIG. 2, variable D denotes disturbances like occupancy and outside temperature, variable T denotes temperature or other variables describing the state of the demands, variable u denotes inputs to control the demand, variable P denotes power, variable DDM denotes disturbances or a disturbance model 241, variable TM denotes a building model 251, variable PM denotes a power model 231, variable u^{s} denotes a supervisory control signal, variable u denotes a local control signal, and variable DM denotes a Demand Management (DM) signal that is supplied to the supervisory controller 210. The DM signal is received from a utility or power provider in terms of a price or the necessary hourly power curtailment. This signal is directly used by the supervisory controller 210. One or more models describing the dynamics of the load of the buildings (provided by the building modeling 250) and the disturbances (provided by the disturbance forecaster 240) and future power demands (provided by the power modeler 230) is used to calculate temperature and other states describing demands. The supervisory controller 210 utilizes this information to decide the sequence of inputs (through optimization and/or advanced control methods) and the local controller 220 executes these inputs/actions on the actual building 299.

The building modeler 250 generates a model 251 (also referred to herein as a “building model”) of a building under consideration. The disturbance forecaster 240 forecasts potential disturbances. The power modeler 230 generates a model 231 (also referred to herein as a “power model”) as described in further detail herein.

In an embodiment, the disturbance forecaster 240 receives forecasts (e.g., from another source) and/or generates its own forecasts.

In an embodiment, the supervisory controller 210 is processor-based. In an embodiment, the local controller 220 is processor-based. In an embodiment, the supervisory controller 210 performs evaluations of respective energy consumptions resulting from different types of control. In an embodiment, the supervisory controller 210 forecasts power demands at the building level responsive to the power model 231.

In an embodiment, the power modeler 230 takes as inputs building power and load measurements in addition to state variables like temperature, which may be measured or obtained by simulating a model of the building, and generates a power model 231. The power model 231 can then be used to forecast future power demands or inverted to calculate the inputs required to achieve a future power demand. This power related information can then be used by the supervisory controller 210 in addition to inputs from the building model 250 and Demand Management signals from the utility, if available. This inclusion of the power variable in making decisions of building level demand management provides flexibility to address concerns of different DR programs. In addition, it provides a way to assess controller 210 and 220 performance based on power and energy consumption rather than just based on states like temperature.

In an embodiment, the power model 231 is built on a time series approach. In an embodiment, the power model 231 can be built using Neural Networks and/or Genetic Algorithms. Of course, the present principles are not limited to the preceding and, thus other modeling approaches can also be used in accordance with the teachings of the present principles, while maintaining the spirit of the present principles. In an embodiment, the time series approach used to model power is the ARX (Auto Regressive with eXogenous inputs) approach. The ARX approach can be represented as follows:

P(t+1)=a₁P(t)+a₂P(t−1)+a₃P(t−2)+b₁X(t)+b₂X(t−1)

where P(t+1) denotes future power demand; P(t), P(t−1), and P(t−2) denote past power measurements; X(t) and X(t−1) denote inputs to the model at the current and past time steps respectively; a₁, a₂, a₃ denote past power measurement coefficients; and b₁, b₂ denote past input coefficients.

The preceding equation relates the future power demand (P(t+1)) to the past power measurements (P(t), P(t−1), P(t=2)) which is the auto regressive part of the model and the future Power demand (P(t+1)) is also a function of t he past values of the inputs (X(t), X(t−1)). The number of steps of past data included in the model is decided based on the desired accuracy of the forecasts and can vary for each building. The model development in the ARX approach can be easily repeated to determine the choice of number of time steps of past data required. The set of inputs described by X can be any subset of power related variables such as indoor, outdoor, and set-point temperatures, power measurements for HVAC systems and other loads and the estimated cooling load. Several other inputs can be included based on the type of building and not all inputs mentioned above are necessary for modeling each building's power demand. These decisions are based on the value of the coefficients obtained in the ARX model. The coefficients themselves can be determined, by various regression methods utilizing collected past data over a given time period (e.g., one application of our approach was able to satisfactorily forecast power demand using a model built on 3 past days of data, however data from more or less than 2-3 days can also be used depending upon the implementation and desired accuracy).

The major advantage of choosing an ARX time series model over Auto Regressive (AR) or Auto Regressive Moving Average (ARMA) is that the model relates variables specific to the building such as indoor temperatures to the power consumed by the load (HVAC devices, and so forth) by utilizing building specific variables as inputs. Thus, by utilizing local information, we can forecast power demands at the building level and evaluate the energy consumption resulting from a particular type of control. In contrast, past work has focused on only using power measurements to predict future power.

Another advantage of our approach is that the ARX power model is invertible. This means that given a future set of power demands to be satisfied (probably through a DM signal), the inverted model can suggest the schedule for indoor temperature/set-point temperatures necessary to satisfy the desired power demand. At the building level the power model can be inverted to obtain the operating schedule or constraints of different devices given the total power demand schedule desired from the building.

FIG. 3 shows an exemplary method 300 for power modeling based building demand management, in accordance with an embodiment of the present principles.

At step 310, receive or generate disturbance forecasts capable of affecting the power supplied to a particular building. Exemplary disturbances include, but are not limited to, outside temperature, occupancy (e.g., a convention at a hotel, where the occupancy is much higher than normal, etc.), and so forth. In an embodiment, step 310 is performed by the disturbance forecaster 240.

At step 320, generate a building model that models building characteristics of the particular building. The building characteristics can be, for example, but are not limited to, thermodynamic characteristics. In an embodiment, step 320 is performed by the building modeler 250.

At step 330, generate a power model that models power characteristics of the particular building. The power characteristics can be, for example, but are not limited to, power demands. The power demands can include, but are not limited to, overall building power demands, building portion(s) power demands, building sub-system demands (e.g., HVAC system, computer system, etc.), and so forth. In an embodiment, step 330 is performed by the power modeler 230.

In an embodiment, the power model can be generated responsive to the building model. In an embodiment, inputs to the power model include measured inputs and forecasted inputs. In an embodiment, inputs to the power model include, but are not limited to, temperatures (e.g., indoor, outdoor, set-point, etc.), power measurements (e.g., overall building, building portion(s), building system(s), etc.), power estimates (e.g., overall building load, building portion(s) load(s), building system(s) load, etc.), building occupancy (e.g., overall building occupancy, building portion(s) occupancy(ies), etc.), and so forth. In an embodiment, outputs from the power model include, but are not limited to, overall building power demands, building portion(s) power demands, building system demands (e.g., HVAC system, computer system, etc.), and so forth.

At step 340, generate a supervisory power control signal responsive to the power model and a demand management input signal. The demand management input signal which is also called the demand response signal is an indicator from the utility with regards to its needs to control its generation and satisfy demand. The most common form in which this signal is provided is in the form of price ($/kWh) of the demand to be serviced. A higher price influencing decision making towards reducing consumption and vice versa. In an embodiment, the supervisory control signal can also be generated responsive to the building model. However, it is to be appreciated that in an embodiment, the power model itself can be generated responsive to the building model. In an embodiment, step 340 is performed by the supervisory controller 210.

At step 350, generate a local power control signal that directly controls characteristics of power supplied to the building or the specific load device(s) in the building whose power consumption is being modeled. In an embodiment, this local control signal is fed back to the power model for use thereby. In an embodiment, step 350 is performed by the local controller 220.

At step 360, generate a schedule of various building power demands (e.g., indoor building setpoint temperatures, lighting levels, and so forth) for one or more portions (e.g., up to and including all portions) of the building responsive to demand data obtained from an inversion of the power model. In an embodiment, the schedule can be for all inputs to all devices/systems in the building. In an embodiment, step 360 is performed by the processor-based supervisory controller.

At step 370, evaluate various energy metrics (e.g., an energy consumption) resulting from a particular control on the power characteristics of the power supplied to the building responsive to the power model. It is to be appreciated that energy consumption evaluation may also be done as a part of providing information or visualization of the building's or device's power consumption. In an embodiment, step 370 is performed by the processor-based supervisory controller.

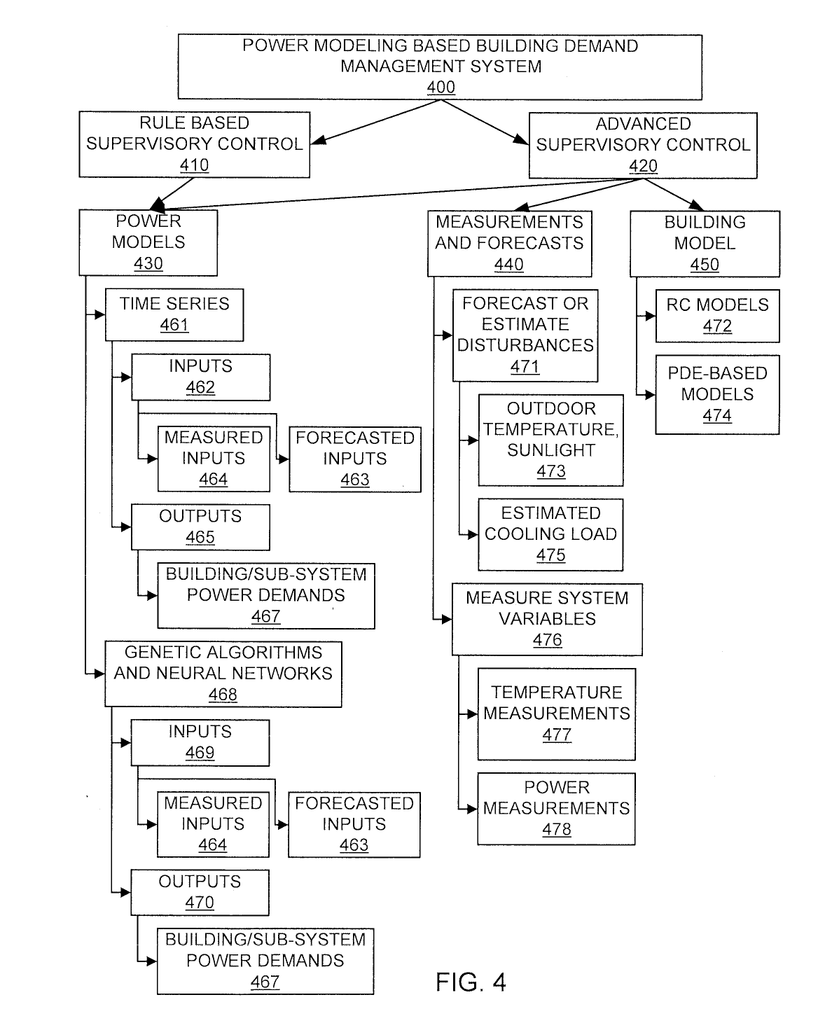

FIG. 4 shows an exemplary architecture 400 for a power modeling based building demand management, in accordance with an embodiment of the present principles. It is to be appreciated that while FIG. 4 describes certain inputs and outputs that can be used in accordance with an embodiment of the present principles, it is to be appreciated that implementations of the present principles are not limited to solely the described inputs and outputs and, thus, other inputs and outputs can also be used as readily determined by one of ordinary skill in the art given the teachings of the present principles provided herein, while maintaining the spirit of the present principles. Moreover, while the power model is described as having outputs, the outputs can be actual outputs resulting from an application run on or using the model or can be data that is modeled by the model including, but not limited to, power demand data.

Two types of control can be utilized in our approach to incorporating power forecast models in building energy management decision making. A simpler rule based supervisory control approach 410 that is based on rules that affect system operation based on threshold levels on different variables such as temperature and power. These rules could be intuitive, simulation studies based or fuzzy logic based rules. Such energy management rules do not work with sophisticated models of buildings 450 but can utilize the measurements and forecasts 440 of important variables. In addition our novel approach enhances rule based decision making by incorporating Power Modeling resulting in a new framework.

Under an advanced supervisory control approach 420, we use an advanced supervisory controller (shown in FIG. 2) for building energy demand management. Advanced control methods utilize building models 450 in conjunction with measurements and forecasts 440. In the advanced supervisory control approach 420, which can involve, for example, but is not limited to, Model Predictive Control (MPC) or Dynamic Programming (DP), the power model 430 can be used standalone or with the building models to provide the necessary forecasts of variables such as power and temperature in order to make control decisions.

The power models can be based on time series models 461 or other complex approaches such as genetic algorithms and neural networks 468. We describe several uses of these algorithms, in the way they utilize the particular inputs 462 and 469 and the outputs 465 and 470 resulting from these models. The inputs are particularly novel because such inputs have not been used in any prior work to forecast power demand at the building level. In addition, these inputs are vital to perform the control actions. The inputs can be categorized into measured inputs 464 and forecasted or estimated inputs 463. With the advancements in the smart grid in relation to improvements in communications, measurements at the building level will become ubiquitous. Thus, we utilize measurements 464 and 467 such as power (of the whole building and of the sub-systems) 478 and temperature 477 in our power models. Similarly certain inputs used in our power model cannot be measured and require estimates 463 and 471 such as cooling load 475 and forecasts of variables such as outdoor temperature 473 The outputs 465 and 467 can include building/sub-system power demands 467.

Finally, the building models 450 can be used with or without the power model to design advanced control strategies. In an embodiment, the building models can be used with the advanced supervisory control (as shown in FIG. 2). The building models describe the thermodynamics in the building and can be Resistance-Capacitance (RC) based 472 or Partial Differential Equation (PDE) based 474.

A description will now be given regarding some of the many attendant advantages of the present principles over the prior art as well as differences there between, in accordance with an embodiment of the present principles.

Advantageously, the present principles provide a model that relates local variables such as temperature set-points, occupancy patterns, and so forth to power consumption of the individual building and its subsystems. Previous approaches consider power forecasts over aggregate loads at the distribution level or the total grid load. Thus, previous work provides no way to relate local variables to local power forecasts.

Moreover, we advantageously, relate the variables (such as indoor and set-point temperatures) through the ARX model, the output of which is forecasted power demand based on building specific variables. Through this output, we are able to incorporate power as a variable in the supervisory control. This means that power related metrics (such as energy consumption) can be optimized or incorporated in the supervisory control to attain a variety of energy related goals. In addition, DR programs are expected to send power demand signals in addition to or separate from price signals. Thus, the addition of the ARX model enables evaluation of DR programs at the building level. Previous work on supervisory control utilizes only the state variables related to the building (like temperature) and cannot provide any guarantees on power consumption.

Further, the power forecasts at the local level can also be advantageously utilized by the utility in improving their total load forecasts and in understanding distribution system loading where past approaches model aggregate power of many buildings based only on past aggregate power demands and do not model down to the building level due to computational challenges.

Also, the model can be inverted to advantageously solve for variables such as the temperature set-points in order to achieve a certain power demand profile from the related devices such as HVAC devices. Since previous approaches do not consider local variables in the power demand it is impossible to obtain schedules for local variables in order to achieve a certain power demand profile.

Thus, the present principles provide a new approach to energy management in buildings, specifically by adding the ability to model and forecast power demand by the building and its subsystems.

Additionally, the choice of an ARX time series model provides many attendant advantages because ARX models are able to incorporate exogenous inputs to the power model thereby enabling the ability to relate these exogenous inputs (such as temperature set-points, occupancy, and so forth) to the power demand.

A description will now be given of some of the many attendant competitive/competitive values of the present principles.

A significant commercial value of the present principles is that they provide substantial flexibility for controller design and power consumption evaluation at the building level. The flexibility of the controller design arises from the fact that interactions with the utility occur through power consumption and associated costs. The present principles help assess the building's ability to interact with different DR programs. In addition, the present principles provide accurate power forecasts at the building level by incorporating building specific inputs such as indoor temperature and temperature set-points. These forecasts can be utilized by both, the utility as well as the building owner in decision making regarding design and control of their energy systems.

Embodiments described herein may be entirely hardware, entirely software or including both hardware and software elements. In a preferred embodiment, the present invention is implemented in software, which includes but is not limited to firmware, resident software, microcode, etc.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable medium such as a semiconductor or solid state memory, magnetic tape, a removable computer diskette, a random access memory (RAM), a read-only memory (ROM), a rigid magnetic disk and an optical disk, etc.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as readily apparent by one of ordinary skill in this and related arts, for as many items listed.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. Additional information is provided in an appendix to the application entitled, “Additional Information”. It is to be understood that the embodiments shown and described herein are only illustrative of the principles of the present invention and that those skilled in the art may implement various modifications without departing from the scope and spirit of the invention. Those skilled in the art could implement various other feature combinations without departing from the scope and spirit of the invention.

What is claimed is:

1. A method, comprising:
generating a power model, modeling power demands of at least one of a building and subsystems thereof, responsive to measured power-related inputs specific to the building and forecasted power-related inputs; and
controlling, by a processor-based supervisory controller, power consumption of at least one of the building and the subsystems responsive to the power demands modeled by the power model.

2. The method of claim 1, wherein the power demands modeled by the power model comprise future power demands, and the power model is generated using time series modeling.

3. The method of claim 1, wherein the power model is generated using genetic algorithms.

4. The method of claim 1, wherein the power model is generated using Neural Networks.

5. The method of claim 1, wherein the measured power-related inputs comprise building-level measurements.

6. The method of claim 1, wherein the measured power-related inputs comprise building-level measurements, the building level measurements comprising at least one of an overall power measurement, a sub-system power measurement, and indoor temperature measurements.

7. The method of claim 1, wherein the forecasted power-related inputs comprise at least one of a forecasted building occupancy, a forecasted cooling load, and forecasted weather conditions.

8. The method of claim 1, wherein the power demands modeled by the power model comprise a heating, ventilating, and air conditioning system power demand.

9. The method of claim 1, wherein said controlling step controls the power characteristics of at least one of the building and devices therein using at least one of model predictive control and dynamic programming.

10. The method of claim 1, further comprising generating a building model, the building model capturing thermodynamic characteristics of the building, and wherein said controlling step controls the power characteristics responsive to the power model and the building model.

11. The method of claim 1, wherein the building model comprises at least one of a resistive-capacitive-based model and a partial-differential-equation-based model.

12. The method of claim 1, further comprising generating a schedule of indoor building setpoint temperatures for one or more portions of the building responsive to demand data obtained from multiple simulations of the power model or an inversion of the power model.

13. The method of claim 1, wherein said controlling step comprises performing rule-based control to determine the power supplied to the building and the subsystems.

14. A non-transitory article of manufacture tangibly embodying a computer readable program which when executed causes a computer to perform the steps of claim 1.

15. The method of claim 1, wherein the power model is generated using time series modeling, the measured power-related inputs comprise building-level measurements, and the forecasted power-related inputs comprise a forecasted building occupancy.

16. The method of claim 1, further comprising evaluating an energy consumption resulting from a particular supervisory control of power supplied to the building responsive to the power model.

17. A system, comprising:
a power modeler for generating a power model, modeling power demands of at least one of a building and subsystems thereof, responsive to measured power-related inputs specific to the building and forecasted power-related inputs; and
a processor-based supervisory controller for controlling power consumption of at least one of the building and the subsystems responsive to the power demands modeled by the power model.

18. The system of claim 17, wherein the measured power-related inputs comprise temperature measurements and power measurements, and the forecasted power-related inputs comprise at least one of a forecasted building occupancy, a forecasted cooling load, and forecasted weather conditions.

19. The system of claim 17, wherein the processor-based supervisory controller generates a schedule of indoor building setpoint temperatures for one or more portions of the building responsive to demand data obtained from an inversion of the power model.

20. The system of claim 17, wherein the processor-based supervisory controller evaluates an energy consumption resulting from a particular supervisory control of power supplied to the building responsive to the power model.
